(19) United States
(12) Patent Application Publication
(10) Pub. No.: US 2017/0277364 A1
(43) Pub. Date: Sep. 28, 2017

(54) USER INTERFACE WITH DYNAMIC REFINEMENT OF FILTERED RESULTS

(71) Applicant: Amazon Technologies, Inc., Seattle, WA (US)

(72) Inventors: Ben Roach, Seattle, WA (US); Sean Bell, North Bend, WA (US); Feryal Khawar, Seattle, WA (US)

(21) Appl. No.: 15/077,781

(22) Filed: Mar. 22, 2016

(51) Int. Cl. G06F 3/0482; G06F 3/0484; G06F 3/16; G06F 3/0485; G06F 3/01; G06F 17/30; G06F 3/0488

(52) U.S. Cl. CPC G06F 3/0482; G06F 17/30867; G06F 17/3089; G06F 3/04842; G06F 3/04883; G06F 3/04845; G06F 3/0485; G06F 3/017; G06F 3/167

(57) ABSTRACT

Electronic devices, interfaces for electronic devices, and techniques for interacting with such interfaces and electronic devices are described. To assist users in accomplishing a search and discovery system and process, electronic devices include a user interface implementing a filter mode in which search results of records are visually presented and dynamically refined to smaller sets of records. Users may interact with the device using touch-screen interactions, representing one example of a user interaction. The user interface may support a user in both entering filter options and applying them to records, while dynamically viewing and scrolling through the resulting filtered records, with multiple interfaces on the user interface remaining operable for user interaction and display of results at the same time.

### BACKGROUND

A large and growing population of users employs various mobile electronic devices or other touch devices with a variety of screen real estate configurations to perform an ever-increasing number of functions. Among these functions, as one example, is consuming and analyzing large data sets, such as filtering them to reduce the number of records returned based on predetermined filters, as one example. Among these electronic or touch devices are smartphones, phones, PDAs, gaming devices, tablets, commercial devices for industrial applications, electronic book (eBook) reader devices, portable computers, portable players, and the like.

The way that users interact with mobile devices continues to evolve. Often, users engage with mobile devices while in transit, thereby reducing their time and attention to interacting with the mobile device in order to accomplish tasks. Concomitantly, the mobility of users has increased the use of easily portable and readily available devices, such as smartphones, and tablets, which may present limited screen real estate. In addition, for the purpose of consuming and analyzing large data sets, where some of the processing includes the transmission of records and their related fields over networks between the device and remote servers, has created a need to reduce the number of user interactions in order to refine data sets. Thus, there is a need for new techniques and interfaces for electronic devices that will improve the refinement of filtered results and user interactions.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example computing environment including a mobile electronic device and content server(s) that may implement a user interface with dynamic refinement of filtered results as described herein.

FIG. 2 is a block diagram of an illustrative computing architecture for content server(s) to support the user interface of the mobile electronic device.

FIGS. 3A-B illustrate an example scenario of the user interface of the mobile electronic device based on a series of user interface displays.

FIG. 4 illustrates a simplified example for a process to generate a combined data structure of one field of a record and one or more filter option selection(s) associated with the field.

FIG. 5 illustrates an example of data structure for the record.

FIG. 6 is a flow diagram showing a process for hosting the dynamic refinement of filtered results.

### DETAILED DESCRIPTION

Described herein is a mobile or other touch device having a user interface to support a dynamic refinement of filtered results in a search and discovery process. The mobile or touch device may be implemented in various form factors, such as a smartphone, portable digital assistant, a tablet computing device, gaming device, or electronic reader device, etc. This disclosure further describes example graphical user interfaces (UIs) or user interfaces) that may be used to interact with an electronic device, including touch-screen options, to transition the device between multiple modes during a dynamic refinement of filtered results.

This disclosure describes, in part, electronic or touch devices, interfaces for electronic or touch devices and techniques that improve the ability of the computer to display information and enhance user interaction experiences. For instance, this disclosure describes example electronic devices that include a user interface implementing a filter mode in which previously generated search results of records are visually presented and dynamically refined to smaller sets of records. Users may interact with the device using touch-screen interactions, representing one example of a user interaction. The user interface may support a user in both entering filter options and applying them to records, while dynamically viewing and scrolling through the resulting filtered records, with multiple windows on the user interface remaining operable for user interaction and display of results at the same time.

In one illustrative example, the filtered results may be a visual identification field for each record in order to optimize the number of records that may be displayed within limited screen real estate. One example of a visual identification field is a thumbnail containing a photograph, drawing or other image or rendering associated with a record (hereinafter referred to as an “image” and/or “visual identification field (VIF)”). The screen real estate may dictate the number of images that may be displayed, and additional images may be revealed by the user scrolling through the displayed images presented in, for example, a banner configuration on the side or bottom/top of the mobile device display.

The mobile electronic device may operate in a filter mode to support the dynamic refinement of filtered results. In the filter mode, the user interface may display multiple windows, such as a results window (which can also be described as an interface or a portion of an interface) and a filter window (which can also be described as an interface or a portion of an interface), in which the user may dynamically interact with the filtered records within the results window, or by select filter options in the filter window. In this manner, the user may iteratively refine filtered records, and both interactions may be operable concurrently, with the filtered records being updated for the user experience at optimized speed to approximate a real-time basis. As a result, the user may dynamically refine the filtered results to arrive at a consideration set that is a manageable size of records for the user's search and discovery process.

In some examples, upon entering the filter mode, the search results may be generated for display to the user based solely on the visual identification field, with one example being an image (such as for example, a thumbnail), displayed as a single field associated with each record. Additional examples of visual identification fields are icons, numbers, colors, shapes or other textual or non-textual identification, or as a combination of one or more individual fields within the record or an associated record. In addition to the visual identification field, each record may also include additional fields, such as, for example, a title description, a summary description, a third party review field, etc.

In the filter mode, a user may interact with the user interface to select which filter options to apply to the records to produce the resulting filtered records. When, for example, an image is selected in the results window, the processing time is optimized for the mobile electronic device to send a transmission call to remote content server(s) in order to generate the filtered records and to respond with a reduced transmission of a single field per record, for example, the image field, back to the mobile device. The reduction in processing time based on the transmission of limited data may approach a real-time processing time for the user experience.

In one example, the filter mode may be entered after an initial search of records is displayed in a search mode of the mobile electronic device. To continue with this example, the user interface, while in search mode, presents an option for the user to select the filter mode after an initial search of the data set has produced search results. Or, in an alternative example, the filter mode and the techniques presented herein, may encompass the entirety of a search strategy so that a filter window (which also may be referred to as a search window in this example) is maintained throughout a search of records.

Starting the filter mode may initiate the rendering of multiple windows on the user interface with one window. One window may be a results window, presenting filtered records based on displaying image fields of the filtered records, in order to optimize the number and transmission speed of filtered records within the limited screen real estate. The results window may be limited due to limitations on screen real estate in displaying more than predefined sets of the image fields, such as for example, 12 records on the display at any given time. The results window may be operable to enable a user to scroll through image field results. Another window may be a filter window, presenting multiple predefined (or user-defined) filter options from which a user may select in order to refine the filtered records in the results window. Both the results window and the filter window may be maintained as operable during processing initiated based on user interaction with either window. When a user interacts with the filter window by selecting filter options, the results window automatically updates the filtered results in the results window and maintains the results window as active during subsequent user interaction with the filter window. In addition, when a user interacts with the results window, for example, by scrolling through the images representing the filtered records, the filter window remains active and available for the user to select further filter options, thereby iteratively refining the filtered records. As a result, the user may dynamically select filter options in the filter window as input to initiate processing of the results window, and concurrently view the results of the filter refinement in the results window without disabling the filter window.

At any point during the iterative refinement or, for example, when the filtered records number is a manageable results set, such as less than 20 or less than the number of images that may be viewed without scrolling on a given user interface (with the number dependent upon the individual users needs and standards in the search and discovery process, so that in some cases hundreds or even thousands of records may be considered to be a manageable results set), the filter mode may be exited by the user selecting one of the images in the results window. One example of how to execute the selection is, for example, executing a double-tap touch input on the image. Exiting the filter mode may return the mobile electronic device user interface to the search mode. This execution approach may result in closure of the filter window so that filter options are no longer available to the user. Further, a transition to the search mode may, in one example, initiate an expansion of the results window to occupy the full screen real estate, thereby providing more data about the filtered records. For example, the filtered records may expand to a presentation format of the search results prior to the filter mode or, in the example presented above, when the mobile electronic device prior to the filter mode, was in the search mode. This may include, for example, an expansion of the number of fields associated with the filtered records. More specifically, for example, title summary and detailed description fields of the record may be added to the display, as well as other fields relevant to a given search and discovery subject matter, such as specification, availability in inventory, etc., or other fields relevant to the subject matter.

A return to or initiation of the search mode may be undertaken when the considered set of records is reduced to a manageable number so that the user benefits from displaying additional information about the records resulting from the use of the filter mode. In alternative examples, the filter mode may be exited based on a toggle button, selection field or any type of button or interaction component (including verbal or audio interactions without the user contacting the interface display, etc., for example) to indicate a user's selection of exiting the filter mode. In one alternative, for instance, exiting the filter mode may for example, expand the results window but maintain a portion of the filter window in order to provide the user with the option of viewing the previous filter option selections, or to enable a return to one or more iterations of previous filtered results.

According to the techniques described herein, and by way of example and not limitation, the starting state of the device may be the search mode, which is maintained until the user executes a filter selection on the user interface, such as a button labeled “Filter.” In other examples, users may interact with the device through other touch interactions (e.g., tap, multi-tap, touch, touch and hold, swipe, and so forth) or through audible verbal interactions, etc. Upon execution of a filter button, the user interface may transition to the filter mode and the user may be visually informed of the search results extant upon entry into the filter mode based on the display of the images in the results window of the filter mode. In addition, the filter mode may trigger rendering the filter window to display the filter options in another area the user interface. In the filter mode, in some examples, the results window and filter window are operable for touch screen entry by the user and processing may occur to approximate on a near-real-time basis.

These and numerous other aspects of the disclosure are described below with reference to the drawings. The electronic devices, interfaces for electronic devices, and techniques for interacting with such interfaces and electronic devices as described herein, may be implemented in a variety of ways and by a variety of electronic devices. Among these electronic or touch devices are smartphones, phones, PDAs, gaming devices, tablets, commercial devices for industrial applications, electronic book (eBook) reader devices, portable computers, portable players, and the like.

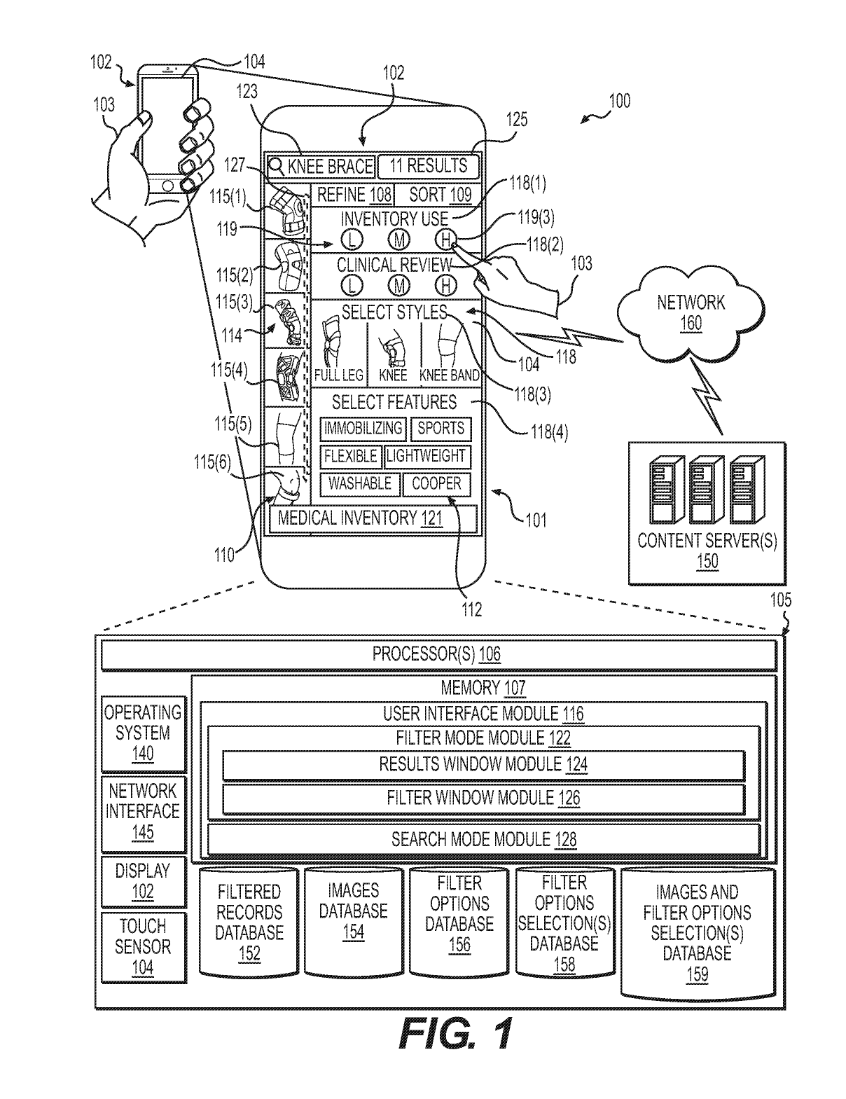

FIG. 1 illustrates an example computing environment including a mobile electronic device and content server(s) to implement a user interface with dynamic refinement of filtered results as described herein. As shown in FIG. 1, a system 100 may include a device 101 including a display 102 positioned or otherwise mounted to the front side of the housing for presenting dynamic refinement of filtered results. A user 103 may interact with a user interface 104 as a component of the display 102. The system 100 may include a user 103 interacting with the device 101 and the device 101 may communicate with one or more remote content server(s) 150 through one or more networks 160.

The display 102 may be formed using any of a number of various display technologies (e.g., LCD, OLED, eInk, and so forth). The display 102 may also include a touch screen operated by a touch sensor 104 and other buttons and user interaction features on smartphones. Other user interaction techniques may be used to interact with the display 102 (e.g., pen, audio, keyboard, and so forth), as well as interactions based on the length of time the user 103 interacts with the screen, such as, for example, depressing a physical or virtual button for a predetermine length of time, etc.

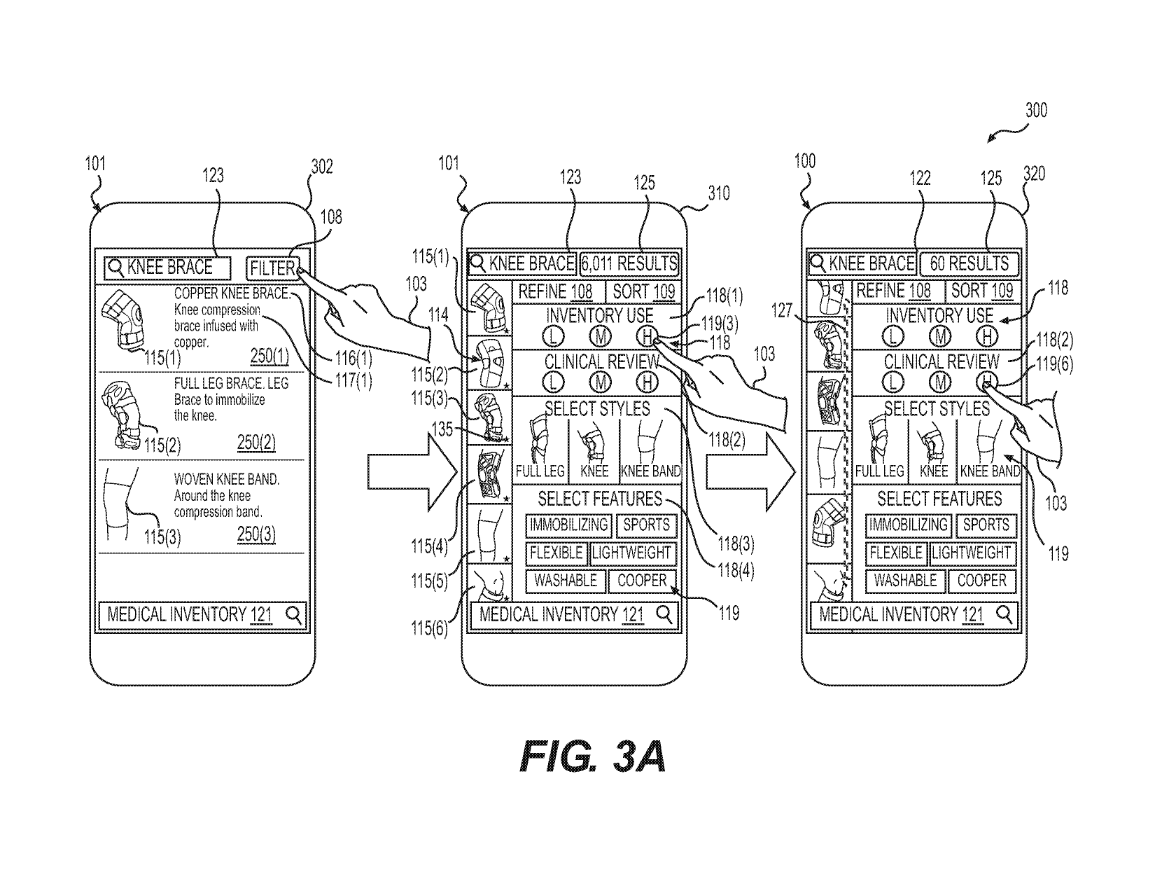

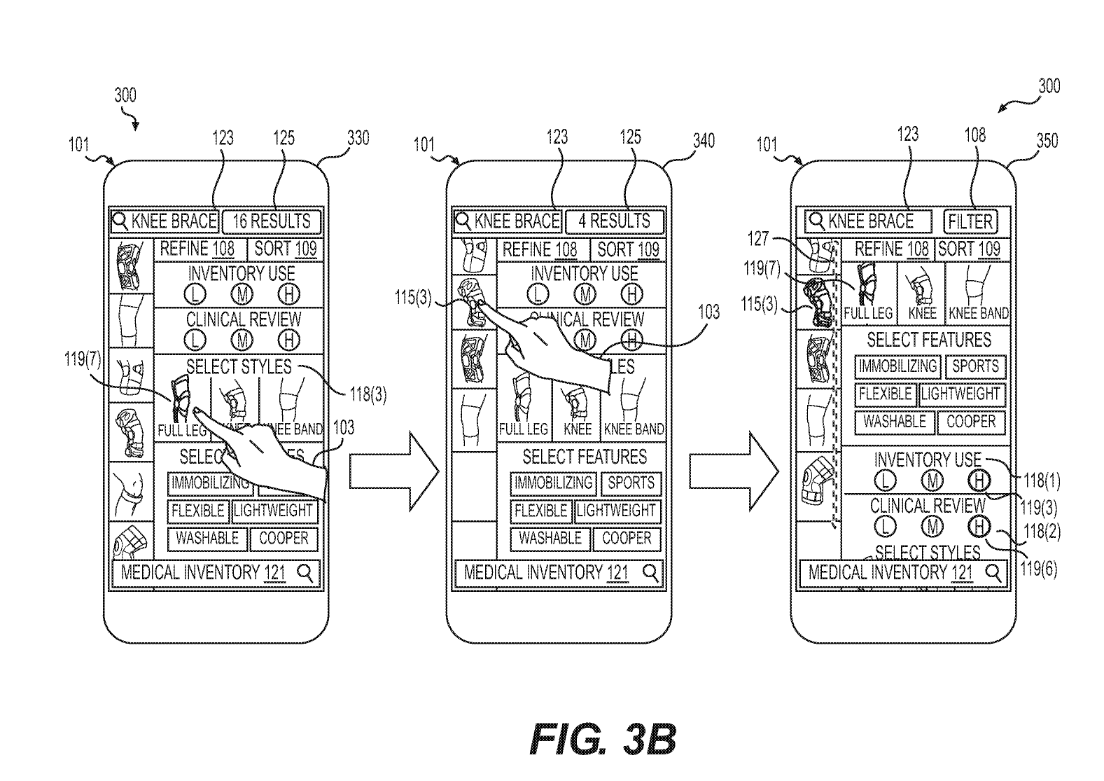

The device 101 shown in FIG. 1 is in a filter mode 111 (with the device 101 operable in a search mode 113 as well, as shown and described regarding FIG. 3A). The device 101, when operating in the filter mode 111, may include two windows, a results window and a filter window 112. The user interface 104 may display the two windows 110 and 112 in combination to produce a composite web page. The device 101 also may include additional sections and buttons of the composite web page for the dynamic refinement of filtered results executed on the device 101. The sections may include: a subject matter section 121, a search entry section 123 and a search results statistics section 127. The subject matter window 121 is the subject matter of an exemplary search and discovery process, labeled in this example as “Medical Inventory.” In the search entry window 123, an exemplary user 103 entry is “Knee Brace.” In the search results statistics section 127, in which the user 103 in this example entered the search “Knee Brace,” an exemplary number of resulting search records is “6,011 Results.” In addition, the device 101 may include a button 108 labeled “Refine” and a button 109 labeled “Sort.” The “Refine” button 108 may be selectable by the user 103 to iteratively apply one or more filter operations to the device 101. The “Sort” button 109 may provide additional options to the user 103 of how to display multiple records within a filtered result, such as alphabetically, etc. In an alternative example, either of the buttons 108 or 109 may be a user 103 activated button to toggle the device 101 between the filter mode 111, as shown in FIG. 1, and the search mode 113 (as shown in FIG. 3A in a user interface display 302).

During the filter mode 111 of operation for the device 101, a set of records 250 created in the search mode 113 may be made available for application of a filter operation. For example, the user 103 entered search criteria in the search entry section 126 that may be applied in the filter mode 111 to the records 250 to produce a set of records 114. The results window provides for the presentation of the records 114. The results window may present the filtered records 114 based on a single visual identification field. In one example, the single visual identification field 115 may be an image, as for example described above as a thumbnail (hereinafter referred to as an image visual identification field (VIF) or “image VIF”).

In this way, the results window may optimize a visual identification of the filtered records 114 within the screen real estate based on a visual presentation of micro content with which a user may efficiently visually review the filtered records 114 within the limitations of the screen real estate. The use of micro content for a visual presentation also supports user interaction with the images VIF 115 based on the device 101 being held in the palm of a user's 103 hand, shown in FIG. 1, and for ready interaction with the user's 103 thumb. The micro content and visual presentation are part of the results window operation to support the user 103 in maximizing the efficiency with which filtered records 114 may be reviewed. In the FIG. 1 results window, multiple images VIF 15(1)-(x) may be displayed and the window 110 may be scrollable to rotate through additional images VIF 115(1)-(x) which may be revealed as through user 103 interaction such as pushing the images VIF in a vertical upward or downward direction along a path indicated by the dotted arrows 127, as one example.

In addition, the FIG. 1 filter window 112 may include a presentation of multiple filter options 118(1)-(x) and is operable to receive user 103 input to select the filter options 118(1)-(x). In this example, based on the subject matter of “Medical Inventory” (as shown in the subject matter section 121), the filter options may include: filter option 118(1) is the “Inventory Use” with three touch screen selections: low (L), medium (M) and high (H); filter option 118(2) is the number of “Clinical Reviews” with three touch selections, low (L), medium (M) and high (H); filter option 118(3) is “Select Style” with three touch screen selections including a visual depiction of the selections with textual descriptions, such as “Full Leg,” “Knee” and “Knee Band,” and filter option 118(4) is “Select Features” with multiple touch screen selections, such as “Immobilization,” “Flexible,” “Sports,” “Lightweight,” “Washable” and “Cooper,” etc. In one example of the operation of the filter mode 111, upon user 103 activation of selections for any of the filter options 118(1)-(4) et. seq., the filtering process may be initiated. Upon user 103 activation of selections for any of the filter options 118(1)-(4) et. seq., the filtering process may be initiated. In alternative examples, filter options 118(1)-(x) may be accumulated and executed together based on the user's 103 selection of the “Refine” button 108 as described above, as another example of the multiple approaches to executing the filter operation.

FIG. 1 also illustrates an example computing architecture 105 which supports the dynamic refinement of filtered results process herein. The computing architecture 105 represents localized computing resources in the device 101. In the illustrated example, the computing architecture 105 may include one or more processor(s) 106 and memory 108. Individual ones of the processor(s) 106 may be implemented as hardware processing units (e.g., a microprocessor chip) and/or software processing units (e.g., a virtual machine). The memory 108, meanwhile, may be implemented in hardware or firmware, and may include, but is not limited to, RAM, ROM, EEPROM, flash memory or other memory technology, or any other tangible medium which may be used to store information and which may be accessed by a processor. The memory 108 encompasses non-transitory computer-readable media. Non-transitory computer-readable media includes all types of computer-readable media other than transitory signals. The memory 108 may be implemented as computer-readable storage media (“CRSM”), which may be any available physical media accessible by the processor(s) 106 to execute instructions stored on the media 107.

As illustrated, the memory 108 may store a user interface (UI) module 116, including a filter mode module 122 and a search mode module 124, a filtered records database 152 (to store filtered records 114), an images database 154 (to store images VIF 115), a filter options database 156 (to store filter options 118), a filter options selection(s) database 156 (to store a filter option selection(s) 120) an images and filter option selection(s) database 159 (to store images and filter option selection(s) 120).

The UI module 116 may present various user interfaces on the display 104 to implement the results window and the filter window 112 to support a dynamic refinement of filtered results in a search and discovery process. For instance, the UI module 116 may initiate the filter mode module 122 to trigger the results window module 124 in order to process the results window and the filter window module 126 in order to process the filter window 112. In one example, processing of the results window module 124 may include managing the rendering of the results window and the interaction by the user 103 with the window, such as scrolling or selection of the images VIF 115(1)-(x). The images VIF 115(1)-(x) on the user interface 104 may comprise an interactive list that is scrollable by the user 103 of the device 101, such as by touch gestures on the display 102. In addition, there are any number of gestures which can be applied to effectuate user interaction with the results window 110, such as for example a scrolling gesture, a swiping gesture, a dynamic sliding gesture, a selection of one of the images VIF 115(1)-(x), or a physical or audio gesture without the user contacting the display screen.

This is shown in FIG. 1 as the scrollable arrow 127 in the vertical orientation associated (it also is shown in FIGS. 3A-3B user interface displays 320 and 350). For instance, the user 103 may swipe horizontally to view different images VIF 115(1)-(x) in the list, and a single image VIF 115(3) in the middle of the list and in front of the other images VIF 115(1)-(x) may have user interface 104 focus at any one time. In some instances, the images VIF 115(1)-(x) comprises a carousel that “loops,” such that a user 103 is able to continuously spin the carousel in a circle, while in other examples the images VIF 115(1)-(x) has two ends and may be scrolled upwards and downwards (or in other examples, where the results window is in a horizontal orientation, leftwards and rightwards).

In addition, processing of the filter window module 126 may include rendering the filter window 112, its contents such as the field option(s) 118 and field option selection(s) 119 and the interaction by the user 103 with the window 112, such as selecting filter option selection(s) 119 (“filter option selections” may also be referred to as “filter options” herein, with both terms describing a list of items which may be selected by the user in the filter window 112).

The UI module 116 may further initiate the search mode module 128 to process the search mode 113 when the user 103 interacts with the user interface 104 of the device 101 to activate a search operation or to initiate the search mode 113, as further described regarding FIGS. 3A, user interface display 302.

As illustrated, the computing architecture 105 of device 101 may further include an operating system 146, a network interface 145 and the touch sensor 104 (as described above). The operating system 146 functions to manage interactions between and requests from different components of the device 101. The network interface 145 serves as the communication component for the device 101 to interact with a network(s) 160. The network(s) 160 may facilitate communications and/or interactions via any type of network, such as a public wide-area-network (WAN, e.g., the Internet), which may utilize various different technologies including wired and wireless technologies. The network interface 145 may communicate with content server(s) 150 through the network(s) 160 to send and receive requests that support the search and discovery process.

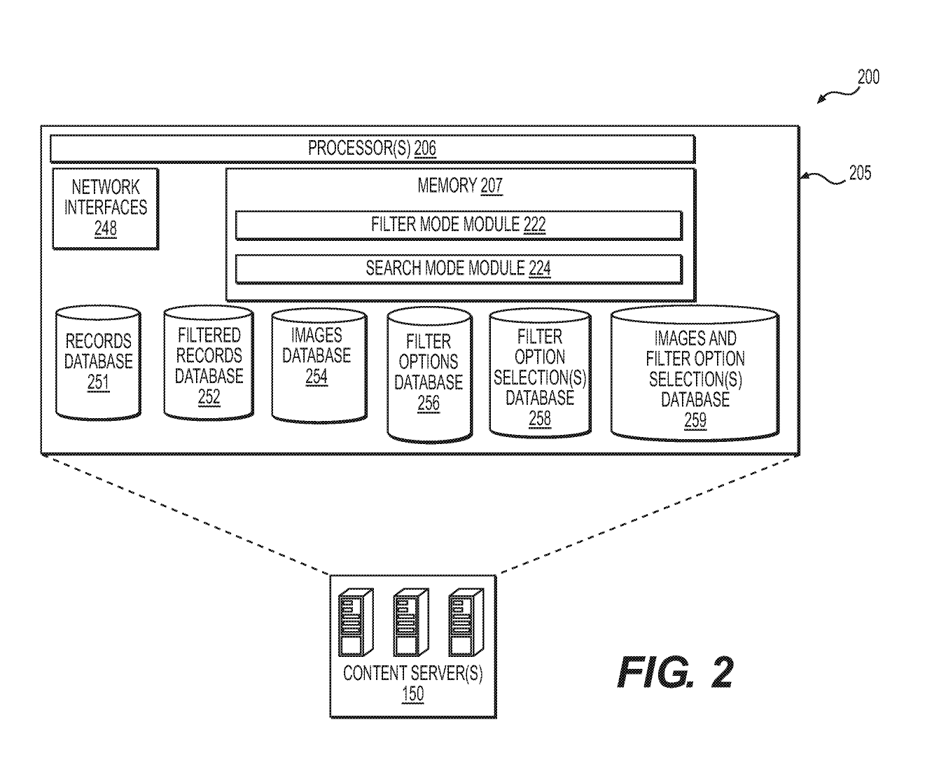

FIG. 1 further illustrates the content server(s) 150. As described regarding FIG. 2, the content server(s) 150 provides computing architecture 205 representing distributed or remote computing resources, such as cloud resources. Together, the computing architecture 105 at the device 101, and the computing architecture 205, which is remotely provided to the user 103 with the search and discovery process. The content server(s) 150 may contain any number of servers that are possibly arranged as a server farm. Other server architectures may also be used to implement the content server(s) 150.

FIG. 2 is a block diagram of an illustrative computing architecture 200 to support the search and discovery process. The computer architecture 200 may be implemented in a distributed or non-distributed computing environment. The computing architecture 200 may include one or more processors 210, and one or more computer-readable media (memory) 220 that stores various modules, applications, programs, or other data, etc. The computer-readable media 220 may include instructions that, when executed by the one or more processors 210, cause processors to perform the operations described herein.

Embodiments may be provided as a computer program product including a non-transitory machine-readable medium having stored thereon instructions (in compressed or uncompressed form) that may be used to program a computer (or other electronic device) to perform processes or methods described herein. The machine-readable storage medium may include, but is not limited to, hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of media/machine-readable medium suitable for storing electronic instructions. Further, embodiments may also be provided as a computer program product including a transitory machine-readable signal (in compressed or uncompressed form). Examples of machine-readable signals, whether modulated using a carrier or not, include, but are not limited to, signals that a computer system or machine hosting or running a computer program may be configured to access, including signals downloaded through the Internet or other networks.

In some examples, the computer-readable media 220 may store a filter mode module 222 and a search mode module 224, as well as one or more network interface(s) 230. The modules are described in turn. The content server(s) 150 may also have access to a records database 251, a filtered record(s) database 252, an images database 254, a filter options database 256, filter option selection(s) database 258 and image and filter option selection(s) database 259. The modules may be stored together or in a distributed arrangement. The network interface(s) 248, similar to the network interface(s) 144 for device 101 serves as the communication component for the content server(s) 150 to interact with the network(s) 160. The network interfaces) 248 may communicate with the device 101 through the network(s) 160 to receive requests and provide responses that support the search and discovery process.

The filter mode module 222 and the search mode modules 224 are now described. The filter mode module 222 processes the filtering operations at the content server(s) 150 based on the receipt of calls from the device 101 during the initiation of the filter mode 111 or during operation of the device 101 in the filter mode 111. The filter mode module 222 may process the receipt of input from the user 103 on the device 101 to initiate the filter mode 111. The filter mode 111 initialization operations may include: generating the initial set of records 114 based on the records 250 to transmit to the device 101 for display on the results window, and generating the filter options 118 based on the records 250 to transmit to the device 101 for display within the filter window 112. The filter mode module 222 may also continue processing filter operations based on the receipt by the processor(s) 220 of the user 103 input while the device 101 is in the filter mode 111.

The filter mode module 222 processing will now be described. In one example, the filter mode 111 is activated from the search mode 113 so that when the filter mode module 222 initiates processing, the records 250 in the records database 251 already have been populated based on a search process. In alternative embodiments, the filter mode 111 may be activated based on other approaches, as is further described regarding the search mode 111 and the search mode module 224 below. To continue with one illustrative example, as shown in FIG. 1 and FIGS. 3A and 3B, the filter mode 111 is activated when the records 250 in the records database 251 have already been populated by the results of the search entered in the search entry section 126 by the user 103 on the device 101 and the device 101 has made a call to the content server(s) 150 to process the search.

Upon receipt by the device 101 of the user's 122 selection of the filter mode 111 from the search mode 113, the device 101 sends a call to the content server(s) 150 to initialize the filter mode 111. The processor(s) 206 activates the filter mode module 222 to store the records 250 generated by the previous the search mode 113 as the filtered records 114 in the filtered records database 254.

Once the search mode 113 results are displayed, a “Filter” button 308 may be presented to enable the user 103 to select the filter mode 111 (as shown and described regarding FIG. 3A, and a UI display 302 of the device 101 in the search mode 113). Upon the user's 122 selection of the “Filter” button 308, the device 101 sends a request or call to the content server(s) 150 to execute a filter operation. The processor(s) 206 initiates the filter mode module 222. The filter mode module 222 applies the search entered in the search entry selection 126 to the filter options 118 of the filter options database 256 in order to generate the filter options 118(1)-(x) to return to the device 101 for display in the filter window 112. The filter module 222 also accesses the images VIF 115(1)-(x) for the set of records 114 associated with the search as processed by the search mode module 224. The filter mode module 222 then returns the images VIF 115(1)-(x) and filter options 118(1)-(x) to the device 101 for display on the results window and the filter window 112, respectively.

After the initial setup of the filter mode 111, based on execution of the filter mode module 222, the filter mode module 222 may then continue processing filter operations based on receipt by the processor(s) 206 of the user 103 input on the device 101 while in the filter mode 111. In one example, in which a user 103 selection of any of the filter options 118(1)-(x) activates a filter operation, such as the user 103 selecting filter option 118(3) “Select Style” and 119(9) “Knee Band,” the device 101 may send a call to the content server(s) 150 to process the filter operation. Upon receipt at the processor(s) 210, the filter mode module stores the filter option selection 120(9) in the filter option selections database 257 and applies the filter option selection 120(9) to the records 250 to produce the filtered records 114 and to generate and transmit back to the device 101 the image VIF 115(1)-(x) for each of the records 114 for display in the results window (as well as storage in the images database 254). In addition, the total number of records 114 is calculated and transmitted to the device 101 for presentation in the results statistics section 125. By limiting for transmission to the device 101 the results of the filter mode module 222 to the image VIF 115 field of records 114, the data for transmission is reduced and, therefore, the transmission speed is increased for receipt of the images VIF 115(1)-(x) at the device 101.

In another example, the filter option selection(s) 120(1)-(x) may be iteratively applied based on each successive user 103 selection of filter options selection(s) 119(1)-(x) so that, for example, each filter option selection 120(1)-(x) produces new filtered records 114, which is smaller than the preceding filtered records 114 until, continuing with the example, the filtered records 114 total number of records is small enough that the images VIF 115(1)-(x), representing the filtered records 114, may be displayed in the results window without scrolling. In this manner, there may be multiple filter option selection(s) 120(1)-(x) which are aggregated and transmitted to the content server(s) 150 over the course of multiple user 103 selections of filter options 118(1)-(x). Upon receipt of each filter option selection(s) 120(1)-(x), the filter mode module 222 stores the filter option selection(s) 120(1)-(x) in the filter option selections database 257, accumulating multiple filter options selection(s) 119(1)-(x) over multiple user 103 selections and calls to the content server(s) 150 and applies the filter options selection(s) 119(1)-(x) to the filtered records 114 stored in the database from the previous filter operation. With each call to the content server(s) 150, the filter mode module 222 generates a new set of filtered records including the image VIF 115(1)-(x) for each of the records 114 and a total number of records for presentation in the results statistics section 125 on the device 101. In this manner, the total number of filtered records 114 displayed in the results statistics section 125 becomes smaller with every additional filter option selection(s) 120(1)-(3). In a related example, the filtering processing as the total number of records 114 becomes small enough to be processed at the device 101 may be executed by the computing architecture 105 at the device 101 so that additional speed is gained in obviating a call to the content server(s) 150. In the FIG. 1 illustration of the display 102, 5 images VIF 115(1)-(6) are shown. Therefore, where the filtered records 114 are 6 or less records 114, then the entirety of the consideration set may be presented on the display 102.

In a related example, the filter mode module 222 may process iterative user 103 selections in which the device 101 enables the user 103 to both select or clear filter option selection(s) 119(1)-(x). There are multiple approaches to enabling these options, such as adding a clear filter option 118(x) which may clear all selected filter option selection(s) 119(1)-(x), adding a clear filter option selection 120(x) which may clear the selected filter options for the associated filter option 118(x), providing a button or other interactive approach for each filter option selection 120(1)-(x) that may be toggled for selection or clearing the selection, etc. In the event that the user 103 deselects filer option selection(s) 119(1)-(x), the filter mode module 222 processing may result in the filtered records 114 total number increasing relative to the preceding result set. Therefore, the filter mode module 222 iterative processing of filter operations may also increase the filtered records 114.

In other examples, the device 101 may operate to initiate the filter mode 111 upon activation by the user 103 of the “Refine” button 108 (shown in FIG. 1) so that any number of filter options selections 119(1)-(x) may be selected at one time and aggregated to create multiple filter option selection(s) 120(1)-(x) prior to transmission to the content server(s) 150 in order to request a filtering operation. Upon receipt of the aggregate filter option selection(s) 120(1)-(x), the filter mode module 222 stores the filter option selection(s) 120(1)-(x) in the filter option selections database 257 and applies the filter option selection(s) 120(1)-(x) to the filtered records 114 to generate a new set of filtered records including the image VIF 115(1)-(x) for each of the records 114 and a total number of records for presentation in the results statistics section 125 on the device 101.

In addition, the content server(s) 150 may also support the storage of a data structure composed of multiple data fields from separate databases, such as the image VIF 115 field of the record 114 (from the images database 254) combined with the filter option selection(s) 120(1)-(x) (from the filter option selections database 260) associated with the image VIF 115. The data structure, hereinafter referred to as images and filter option selections 120, may be stored in separate database(s) in either or both of the content server(s) 150 (not shown) or the device 101 (shown in FIG. 1 in the device 101, images and filter option selections database 121) based on transmission by the filter mode module 222 to the device 101, or based on processing locally at the device 101. The images and filter option selections 120 may be used to display the filter option selection(s) 120(1)-(x) for a given image VIF 115 in the filter mode 111 on the display 102. Where the images and filter option selections 120 is stored at the content server(s) 150 in the database 262, it may be transmitted upon receipt of a user 103 request from device 101 for the filter option selection(s) 120(1)-(x) for a given image VIF 115 selection. For example, upon a single tap or other indication of selection of an image VIF 115 for the purpose of revealing the filter option selection(s) 120(1)-(x) associated with the image VIF 115 (as opposed to a selection to reveal additional data about the record 114 associated with the image VIF 115 and/or return to the search mode 113), the device 101 sends a request to the content server(s) 150 for the images and filter option selections 120. The data structure may then be used to display the associated filter option selection(s) 120(1)-(x) in the filter window 112. This is shown and further described regarding FIG. 3B and the UI display 360. For additional examples, the images and filter option selections 120 may include every filter option selection 120(1)-(x) associated with the image, including those that the user 103 may not have selected. In this manner, the most refined set of filter option selection(s) 120(1)-(x) is displayed for a given image VIF 115.

Filter mode module 222 processing to reduce the filtering operation result for filtered records 114 to the single data field of the image VIF 115(1)-(x) for transmission to the device 101 increases the transmission speed of the results to the device 101. In addition, the reduced data of the image VIF 115 for display increases the amount of data that may be displayed for the user 103.

The search mode module 224 processes the search operations at the content server(s) 150 based on the receipt of calls from the device 101 during the search mode 112. Upon receipt by the processor(s) 206 of a search operation while in the search mode 112, the search mode module 224 applies the search entry in the search entry section 128, such as, for example, “Knee Brace” as shown in FIG. 1, to a database (not shown) in order to identify records 250 and to populate the records database 251 with such records 250. The records database 251 is then available when the device 101 is transitioned to the filter mode 111 for use by the filter mode module 222 to apply the filter operations to the records 250. The records 250(1)-(x) may also be displayed during the search mode 113 on the display 102, including a select number of fields for each record, shown and discussed further below, for example in FIG. 3A, the UI display 310.

Upon completion of a search operation in the search mode 113, the records 250 are displayed on the device 101, such as is shown in FIG. 3A UI display 310. When in the search mode 113, the device 101 may enable the user 103 to transition to the filter mode 113 based on a number of approaches. For one example, the UI display 310 includes a “Filter” button, which may be activated by the user 103 as one approach to enabling the user 103 to activate the filter mode 111. Upon the user's 122 activation, the device 101 may send a call to the content server(s) 150 to initiate the filter mode 111. When the processor(s) 206 receives the request, the filter mode module 222 is initiated and the processing continues as further described above for the filter mode module 222.

In this illustrative example, the filter mode 111 is triggered based on the device 101 operating in the search mode 113. The device 101 also may transition from the filter mode 111 to the search mode 113. One example of one of the multiple approaches described herein for this transition is the user 103 selecting one of the images VIF 115 in the results window. The device 101 may then send a call to the content server(s) to request a transition from the filter mode 111 to the search mode 113. Upon receipt by the processor(s) 206 of the user's activation of the search mode 113, the search mode module 224 may process the filtered records 114 to identify additional fields 116, 117, etc., associated with each filtered record 114 and transmit the filtered records 114 including the additional fields to the device 101 for presentation in the search mode 113 on the display 102. FIG. 3A UI display 310 is one example of the presentation of records 114 with additional data per record presented for the user 103, as is further described regarding FIG. 3A.

In other examples of the use of the content server(s) 150, the filtered records 114, including all records fields 115, 116, 117, etc., may be transmitted back to the device 101 and then the filter mode module 136 of the computing architecture 105 may process the filtered records 242 to identify for display the images VIF 115. In addition, the filter option selection(s) 120 need not be processed and appended to the filtered records 114. Rather, the filter option selection(s) 120 may be maintained based on the user 103 input at the device 101 for retrieval and processing by the filter mode module 138 locally. In other examples, the data structures of the filtered records 114, filter option selection(s) 120 and images VIF 115 may be stored at both or either of the device 101 and the content server(s) 150. Where they are stored at the content server(s) 150, the data may be transmitted for use by the device 101 with reduced transmission speed based on transmitting a limited amount of data, such as the images VIF 115. Upon receipt of the images VIF 115 at the device 101, the filter mode module 134 may associate the images with the filter option selection(s) 120 entered by the user 103 on the display 102 of the device 101, thereby combining transmitted data and the images VIF 115, with local data, the filter option selection(s) 120, to reduce transmission speed. In some examples, the data may be stored at both the device 101 and the content server(s) 150 and the processing may occur both locally, at the device 101, or remotely based on a call to the content server(s) 150. The processing distribution may also be a function of the volume of the filtered records 114 so that as the volume of these records is reduced such that the processing capacity at the computing architecture 105 is fast enough to support dynamic processing, then the processing may be executed by the filter mode module 134 at the device 101. The processor(s) 130 and operating system 140 may manage the distribution of processing, local storage at the device 101 and/or remote storage at the content server(s) 150 to optimize transmission speeds depending upon the volume of data being processed and transmitted.

FIGS. 3A-B illustrate, in an example scenario of the user interface (UI) of the device 101, including a series of user interface (UI) displays 302, 310 and 320 in FIG. 3A and 330, 340 and 350 in FIG. 3B captured at different points in the dynamic refinement of filtered results in a search and discovery process. In this example, the device 101 begins by displaying a UI display 302 from an example search of a database (e.g., medical device inventory, catalog, members of an insurance or medical program, etc.). The database to be searched is shown in the search subject matter section 121 as “Medical Inventory” and the subject matter of the filter search is shown in search entry section 123 as “Knee Brace.” This type of search may be initiated, for example, by a physical therapist seeking to identify a knee brace for a patient. The results of the search are shown on UI display 302 as 3 records 114(1)-(3) for a knee brace search, including for each record 114(1)-(3), a visual identification field such as images VIF 115(1)-(3), a title description field 336(1)-(3) and a detailed description field 337(1)-(3), as examples of the fields which may be presented for records 114(1)-(3). When the device 101 presents the UI display 302, the user 103 selects (e.g., touches, depresses or manipulates, etc., as processed by the touch sensor 104 of the computing architecture 105) the virtual or physical button 108 on the device 101 UI display 302. In this example, the button 108 is virtual and is labeled “Filter.” This button 108 may present a filter mode 111 selection option that, when activated, causes the device 101 to transition from the search mode 113 to the filter mode 111. In this example, the user 103 taps or otherwise selects the button 108. When selected, the device 101 may provide any number of feedback confirmations to the user 103 that the selected button 108 was indeed selected. For instance, the button 108 may change appearance (e.g., flash, change color or transparency, etc.). In response, the device 101 navigates to a starting UI display 310 of the filter mode 111.

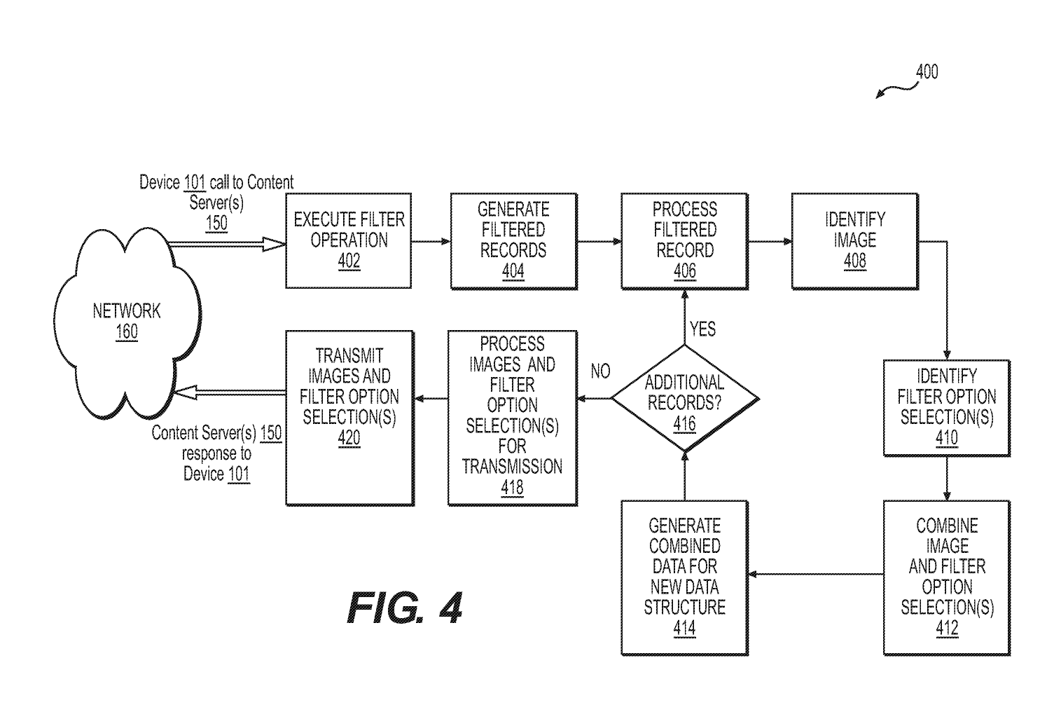

In the starting UI display 310 of the filter mode 111, the display 310 presents the two primary windows: the results window and the filter window 112. For this example, the results window is on the left vertical side of the device 101. The records 114 which resulted from the search inquiry executed in UI display 302 continue to be displayed. However, the presentation of the records 114 has transitioned from the display in the search mode 113 to the display in the filter mode 111 based on reducing the number of fields rendered for each record 114 to the images VIF 115(1)-(5) corresponding to each of the records 114. With the use of solely a visual identification field 115, and the screen real estate occupied by the images VIF 115, a larger number of total records 114 may be displayed than in the search mode. More particularly, in this example, the UI display 310 results window displays 5 records 114(1)-(6) based on the single field of a visual identification images VIF 115(1)-(6). In this manner, and in contrast to the search mode 112 where records 114(1)-(3) are displayed, the filter mode 111 provides an increase in the volume of images VIF 115(1)-(6) (one for each record 114(1)-(6)) displayed with UI interface 310. In addition, the reduction in the fields for each record 114 displayed may reduce the processing time, latency and data volume for the transmission of records 114 when the device 101 calls the content server(s) 150 to execute a filter operation and return filtered records 114, as described in more detail regarding FIG. 4.

In the starting UI display 310 of the filter mode 111, the display 310 also presents on the right vertical side of the device 101 the filter window 112. As described regarding FIG. 1, the filter window 112 includes a presentation of filter option(s) 118 and is operable to receive user 103 input to select filter option(s) 118. Multiple filter options are presented as 118(1)-(4) in the filter window 112 (with additional filter options 118(x) et. seq. being revealed by scrolling the filter options viewable on the UI display 310 using a scrolling function, an example of which is shown in FIG. 1 UI display 104). In this example, based on the subject matter shown in the subject matter section 121 of “Medical Inventory,” for example, filter option 118(1) is the “Inventory Use” with three touch screen filter option selection(s) 120(1) low (L), 119(2) medium (M) and 119(3) high (H); filter option 118(2) is the number of “Clinical Reviews” with three touch selections, 119(4) low (L), 119(5) medium (M) and 119(6) high (H); filter option 118(3) “Select Style” with three touch screen selections including a visual depiction of the selections with textual descriptions, such as 119(7) “Full Leg,” 119(8) “Knee” and 119(9) “Knee Band,” and filter option 118(4) “Select Features” with multiple touch screen selections, such as 119(10) “Immobilization,” 119(11) “Flexible,” 119(12) “Sports,” 119(13) “Lightweight,” 119(14) “Washable” and 119(15) “Cooper,” etc. Upon user 103 activation of selection(s) 119(1)-(15) (selected 119 reference numbers are shown for illustration purposes in FIGS. 3A-3B) for any of the filter options 118(1)-(4) et. seq., the filtering process may be initiated. In this example, the filter options 118(1)-(4) are shown in the starting UI display 310 for the filter mode 111 initially with the filter options 118(1)-(4) shown and the user 103 selecting the filter option 118(1) for “Inventory Use” and 119(3) “High.” Upon user 103 activation of filter option selection 120(3), the filter mode 111 operation may be executed as a response to the selection or the selection may be indicated by a color or other change in the filter option selection 120(3) “High” section to provide feedback to the user 103, followed by executing the filter mode 111 operation. Alternative approaches to triggering the filter mode 111 are described regarding the “Refine” button 108 as described regarding FIG. 1 above and further described regarding FIG. 3A below.

The UI display 310 also provides the following sections, the search subject matter section 121 labeled “Medical Devices,” the search entry section 123 with “Knee Brace” entered by the user 103 and the search results statistics section 125 with initial results of a volume of “6,011” results or records for the “Knee Brace” filter operation.

In addition to the button 108, two additional buttons 108 and 109 may be presented, which in this example are virtual and displayed on the UI display 310. Both of the buttons 108 and 109 may be activated using the same alternatives as button 108, including the construction of the buttons as physical or virtual and the activation mode of the buttons, such as for example, through touch screen interaction with the user 103. In this example, button 108 is labeled “Refine.” This button 108 may be activated by the user 103 to trigger a filter operation using one or more filter option(s) 118 selected in the filter window 112. As further described below, the filter operation applies the filter option selection(s) 120 from the filter window 112 to further refine the records 114 presented in the results window. By enabling multiple selections by the user 103 of filter option selection(s) and thereafter initiating the filter mode 111 filter operation upon selection of the “Refine” button 108, the user 103 may select multiple filter option selections 119(1)-(4) et. seq. to be aggregated as a filter set in the filter operation to produce a refined set of records 114. In another example, a filter operation may be applied upon a single filter option selection 120 within the filter window 112 so that any data entry into the filter window 112 initiates a refinement of the images VIF 115 shown in the results window. In the example of the FIGS. 3A-3B, UI displays 310, 320, 330, 340 and 350, the refinement of records 114 shown in the results window occurs based on a selection of the “Refine” button 108 after one or more filter option selection(s) 120(1)-(x) are selected by the user 103.

In addition, the “Sort” button 109 may server the same function of enabling the user 103 to change the sorting options for the records in the results window. With the limited screen real estate, however, until the filtered records 114 is of a manageable number of results which may be analyzed by the user 103, the changes in the display of the images VIF 115(1)-(x) may not be made at each refinement. For example, where the filtered record 114 volume of records is large, such as in the 100,000s, the refinement of filter results 114 may not result in any change to the visible images VIF 115(1)-(6) shown on the UI display 310. The impact of filtered records 114 refinement becomes more meaningful as filtered records 114 are reduced to a manageable volume, such as, for example, in the 100s or less, or within a reasonable range given the original database 251 to which the search is applied, so that the number is subjective for any user 103 but the likelihood of the images VIF 115(1)-(x) changing increases as the number of records approximates the number of visible images VIF 115 on the user interface 104 of the device 101.

The location and orientation of the results window and the filter window 112 are additional examples of different approaches to presenting the filtered records 114 on the screen real estate. In other examples, other orientations may include windows which are aligned in a horizontal orientation or stacked on top of one another, records from the windows may be intermixed and/or filter window 112 filter options 118 and filter option selection(s) 120 may be in a central location surrounded by results window 112 images VIF 115.

In addition, as also described regarding FIG. 1, at the same time that the filter window 112 is operable to receive user 103 input to select filter option(s) 118, the results window remains operable on a real-time or approximately real-time basis to receive user 103 input. Such user input may include interaction with the images VIF 115(1)-(6) such as by a scrolling function, which expands upon the images VIF 115(1)-(6) available to review but does not activate a selection of any one of the images VIF 115(1)-(6), or a selection of one of the images VIF 115(1)-(12) to transition the device 101 into the search mode 113.

In this way, the user 103 is supported in the filter mode 111 to both select filter option(s) 118 in order to execute iterative filter operations for the filtered records 114, while at the same time, dynamically and approximating real time, viewing and scrolling through the resulting filtered records 114 in the results window. In this manner, in filter mode 111, both of the results window and the filter window 112 are maintained as operable during processing initiated based on user 103 interaction with either window 110 or 112. When a user interacts with the filter window 112 by selecting one or more filter option(s) 118, the results window automatically updates the images VIF 115(1)-(6) in the results window 112 and maintains the results window 112 as active during subsequent user 103 interaction with the filter window 112. In addition, when a user 103 interacts with the results window, for example, by scrolling through the images VIF 115 representing the filtered records 114(1)-(6), the filter window 112 remains active and available for the user to input further filter option(s) 118, thereby refining the resulting filtered records 114. As a result, the user 103 may dynamically select filter option(s) 118 in the filter window 112 as input to initiate processing of the results window and concurrently view the results of the filter refinement in the results window without disabling the filter window 112. The records 114 therefore may be visually presented and dynamically refined to produce smaller results sets, thereby arriving at a consideration set that progresses to a manageable size of filtered records 114 for the user's 103 dynamic refinement of filtered results in a search and discovery process.

From the UI display 310, the user 103 also may return to the search mode 113 by selecting any of the images VIF 115(1)-(6). The user's 103 selection may return the device 101 to the search mode 113, such as is presented on the UI display 302 based on pre-determined sorting criteria, or a different pre-determined sorting criteria may be applied for results window selections in the case where the search mode 113 is restarted after the device 101 has been in the filter mode 111 in alternative examples. In the event that the UI display 310 is navigated back to a search mode 113, in one example, the filter window 112 is deactivated and therefore not available for selection by user 103 in the search mode 113 (as shown for example in the search mode 113 UI display 302 of FIG. 3A or the presentation of the search mode 113 user interface 104 of the device 101 prior to entering the filter mode 111). Continuing with this example, the operability of the filter window 112 is a function of the mode of operation of the device 101, in which the search mode 113 provides search records 250 without a concomitant operable filter window 112 and the filter mode 111 provides filtered records 114 in the form of the images VIF 115 in the results window while at the same time maintaining as operable for further user 103 input, the filter window 112.

The FIG. 3A UI display 310 also illustrates another example of the images VIF 115(1)-(6). One purpose of the images VIF 115(1)-(6) may be to convey a maximum amount of information within the limited screen real estate. In addition to an image, thumbnail, pictorial etc., an additional piece of information may be added. The information can be repetitive of other information provided on the UI display 310 or a new piece of information unrelated to the filter options 118, it may be pictorial, context, audio or other form of information, including for example, a badge, icon, star or other symbol. In the example as illustrated, an additional piece of information is a star. One example of information indicated by the illustrative star 135 shown in the UI display 310 is a high usage in inventory, which relates to the filter options 118 in the filter window 112. The addition of two pieces of information in the images VIF 115(1)-(6) may support the user in more efficiently using the UI display 310 information to refine the records 115. The star 135 is shown in UI display 310 for illustrative purposes and is not continued to be shown in the additional UI display 320 in FIG. 3A or in the FIG. 3B illustration.

In response to the user 103 selecting the “Inventory” and “High” filter option 118(1) on a second UI display 310, another filter operation may be triggered. As a result, as shown in the third UI display 320, the filtered records 114 may be iteratively filtered to generate a subsequent set of refined filtered records 114, which may change the images VIF 115(1)-(6) displayed in the results window, as well as presenting a number volume of records as presented in results statistics section 125, with in this example “60 results” being displayed. The UI display 320 shows both the device 101 in the filter mode 111, with both the results window and the filter window 112 operable to receive further input or interactions by the user 103 such as a further selection of another filter option 118(1)-(4) or scrolling through the images VIF 115, respectively. This UI display 320 further presents the user 103 selecting filter option 118(2) “Clinical Review” and filter option selection 120(6) “High.”

In FIG. 3B, a fourth UI display 330 shows the result of the user 103 selection of the filter option selection 120(6) in UI display 320. Similar to UI display 320, the UI display 330 filtered the earlier filtered records 114 to generate a new set of filtered records 114, which may change the images VIF 115(1)-(8) displayed in the results window. In addition, in this example, which is based on the user 103 selecting the filter option 118(2) “Clinical Review” and 119(6) “High,” the volume of records has decreased, as presented in search results statistics section 125, with “16 results” displayed. The basis for this decrease in volume in this example is that the filter operation is applied to the filtered records 114 presented in UI display 320. In alternative examples, the filter operation may be performed on another set of records, such as records 250, as shown in FIG. 2, rather than on the previous reduced set of records 114 presented in the UI display 320. In these alternative examples, the filtered records 114 may be an increase in the total number of records 114. With both the results window and the filter window 112 continuing to be operable, the user 103 may interact with either window 110 and 112 and trigger dynamic filter operations and updates to each of the windows 110 and 112 resulting from data entry in the filter window 112. As a further presentation in this exemplary UI display 330, the user 103 selects filter option 118(3) “Select Style” and filter option selection 120(7) “Full Leg.”

In addition, where the total number of records 114 is within a range for which processing of the records 114, including an application of a filter operation to the records 114, may be completed within an acceptable time period in which the images 115 may be rendered on the results window 110, all of the processing may be executed locally at the device 101. In this alternative example, the device 101 does not send a request to the content server(s) 150 as the completion of processing may be managed by the computing architecture 105 of the device 101. The determination of an acceptable time period and a reasonable number of records 114 may be determined based on the specifications of the device 101 and standard processing time for local processing versus the use of computer network transmissions.

A fifth UI display 340 results from the user 103 filter option 118(3) and filter option selection 120(7) in which, based on data entry to the filter window 112, the filter operation may be executed and updates to the records 114 display of images VIF 115(1)-(4) and volume of filtered records are presented. With the total volume of filtered records 114 being four (4) and less than the predetermined number of image VIF 115(1)-(6) screen capacity, in this example, the images VIF 115 presented in the results window do not occupy the entire results window. This may be beneficial to the user 103 in visually presenting that the filtered records 114 is indeed small enough for consideration in a single UI display 340 without a need to scroll the images VIF 115(1)-(4). In an alternative example, the 4 images VIF 115(1)-(4) may be reformatted by increasing the dimensions of the images VIF 119(1)-(4) themselves to magnify viewing each image VIF 115(1)-(4), as well as to fill the capacity of the results window. In this example, the UI display 340 may provide a different indication that the images VIF 115(1)-(4) are the final filtered records 114 and no scrolling is needed, or on the other hand, scrolling may continue to be enabled for the reduced number of images VIF 115(1)-(4) such as earlier or similar results being added to the UI display 340, and indicated as such with some indication on the images VIF 115(5)-(x) of the basis for their addition.

In addition, in an alternative example, the UI display 340 may be used to illustrate an additional interoperability of the results window and the filter window 112. In this alternative example, the results window may be operable to support the user 103 indicating one of the images VIF 115(1)-(4), such as image VIF 115(3), in order to prompt the filter window 112 to display the filter options and filter option selection(s) 120(1)-(x) corresponding to the indicated image VIF 115(3). In this way, the dynamic operability of the multiple windows, the results window and the filter window 112, is presented in an additional manner to provide the user 103 with filter options and filter option selection(s) 120(1)-(x) which correspond to a selected image VIF 115(3). One example of the indication of the image VIF 115(3) in this example is a single tap of the touch screen 104 on the UI display 340, while a double tap may trigger a selection of the image VIF 115(3) in a manner of triggering a return by the device 101 to the search mode 113 from the filter mode 111. There are alternative approaches to supporting indications by the user 103 for the operations in these examples, such as swipe movements, hold movements etc. In addition, in this example, there are multiple approaches to presenting the filter option selection(s) 120(1)-(x) associated with the selected image VIF 115(3), including every one of the filter option selection(s) 120(1)-(x) stored at the contents server(s) 150 or a more limited set of the filter option selection(s) 120(1)-(x) including only those filter option selection(s) 120(1)-(x) which have been activated by the user 103 previously during the user's 103 interaction with the device 101 in the filter mode 111. In either case, the device 101 may send a request to the content server(s) 150 to identify the filter option selection(s) 120(1)-(x) associated with the selected image VIF 115(3).

The result of this additional interoperability in the filter mode 111 is shown in the UI display 350 with the image VIF 115(3) shown as selected and the filter window 112 presenting the one or more filter option(s) 118(x) and filter option selection(s) 120(1)-(x) which correspond to a selected image VIF 115(3). The filter options 118(1), (2) and (3) are shown as associated with the image VIF 115(3), which has been indicated by the user 103 based on a highlighting of the image VIF 115(3) with a border around the pictorial. In this example, the filter option(s) 118(1), (2) and (3) indicated are the accumulation of the filter selection option(s) 119(3), (6) and (7) in the preceding UI displays 320, 330 and 340 presented in FIGS. 3A-3B.

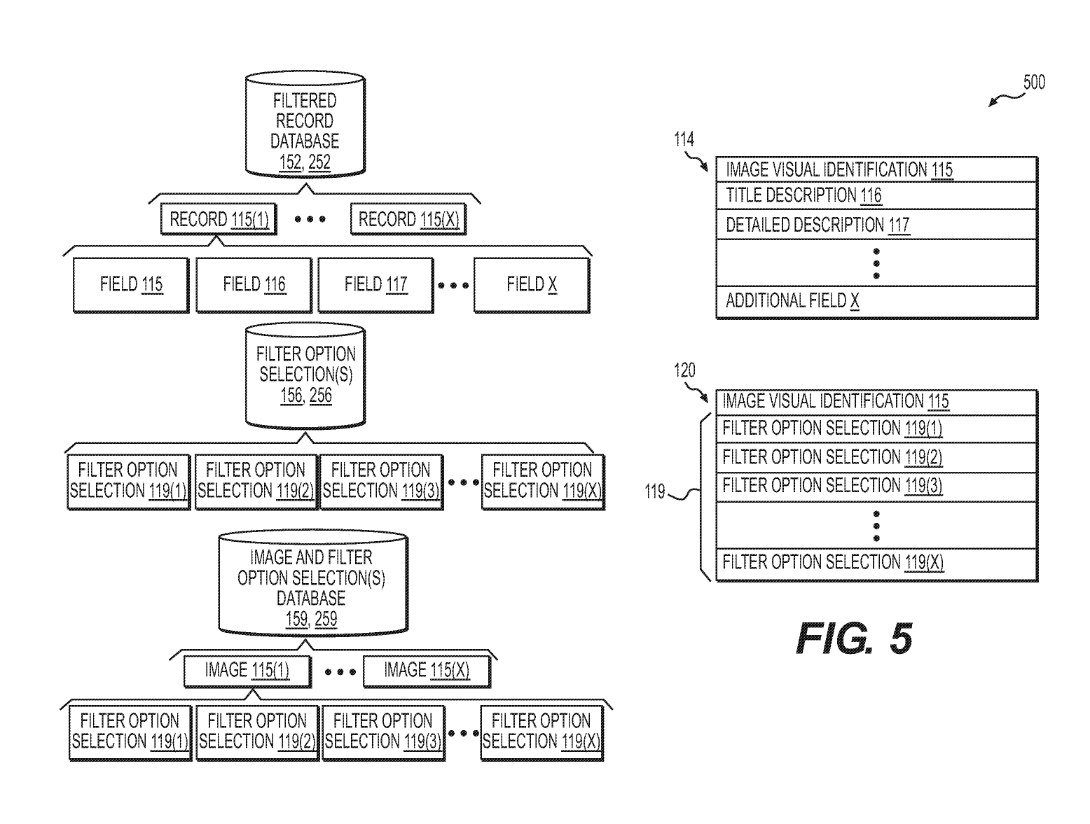

FIG. 4 illustrates a simplified example for a process 400 to generate a combined data structure of an image VIF 115 field of filtered record 114 and the filter option selection(s) 120 associated with the image VIF 115. The combined data structure is herein referred to as an images and filter option selection(s) 120, described above regarding FIG. 2. As shown in step 402, the process 400 may initiate upon receipt by the content server(s) 150 of a call from the device 101 for a filter operation while the device 101 is in the filter mode 111. In step 404, the filter mode module 222 generates filtered records 114 by applying the data input from the device 101, including the user 103 selected filter option selection(s) 120(1)-(x), to the records 114 to identify an iterative subset of the filtered records 114. Step 406 involves the filter mode module 222 processing the filtered records 114. The process is applied to individual filtered records 114(1)-(x), and starts with identifying the image VIF 115, as shown in step 408. Then, in step 410, the filter option selection(s) 120(1)-(x) associated with image VIF 115 are identified. The filter mode module 222 then, in step 412, combines data from separate databases (e.g., the image VIF 115 stored in the images database 254 and the filter option selection(s) 120(1)-(x) stored in the filter option selection(s) database 258, as shown and described in FIG. 2), to generate in step 414 the new data structure, images and filter option selection(s) 120. The new data structure is further described in FIG. 5.

The content server(s) 150 processor(s) 206 then determines, in step 416, whether there are additional filtered records 114 to process. If there are additional filtered records 114, then the filter mode module 222 continues to process the additional filtered records 114 in step 406. If the complete set of filtered records 114 is processed; i.e., the processor(s) 206, in step 416, determines that there are no more filtered records 114 to be processed, then the filter mode module 222 processes the images and filter option selection(s) 120(1)-(x) in step 418. The processing may include storage, or cache, of the images and filter option selection(s) 120 at the content server(s) 150 images and filter option selection(s) database 259 as one example. In an alternative example, the images and filter option selection(s) 120 need not be stored at the content server(s) 150 images and filter option selection(s) database 259 and rather it may be solely transmitted for use by the device 101. In step 420, the images and filter option selection(s) 120(1)-(x) may be transmitted to the device 101 in response to the call by the device 101 with the transmission occurring over the network(s) 160.

In an alternative example, the content server(s) 150 may provide a set of images VIF 115(1)-(x) based on a predetermined filter option selection 119(x) to the device 101 in order to decrease the processing time of transmitting data over the computer network only upon the user 103 selection of a filter option selection 119(x). The content server(s) 150 processing may identify a filter option selection 119(x) that is commonly selected based on a preceding filter option selection 119(y). Then, the content server(s) may apply the predetermined filter option selection 119(x) to the records 114 in order to generate a filtered set of images VIF 115(1)-(x). This filtered set of images VIF 115(1)-(x) may then be transmitted to the device 101 so that in the event that the user 103 chooses the filter option selection 119(y), then the results images VIF 115(1)-(x) for presentation in the results window 110 are local at the device 101. Therefore, the processing time for the local resulting images VIF 115(1)-(x) corresponding to the predetermined filter option selection 119(y) will be shorter than the processing time where the resulting images VIF 115(1)-(x) are generated after the user 103 selection and subsequent call to the content server(s) 150 to provide a response. In another example of this pre-processing approach, the device 101 may transmit to the content server(s) 150 a request for a pre-fetch of images VIF 115(1)-(x) associated with filtered records based on a predetermined one of the plurality of filter option selections 119(y). The device 101 may identify the predetermined one of the plurality of filter option selections 119(y) or the content server(s) 150 may transmit the predetermined one of the plurality of filter option selections 119(y) to the device 101 to make it available to the device when the user 103 selects the predetermined one of the plurality of filter option selections 120(y). In addition, in another example of a pre-fetch operation, the device 101 can transmit a request to the content server(s) 150 to request the plurality of records 114 associated with current filter option selection 119(y) and/or its associated images VIF 115(1)-(x) in order to receive and store at the device 101 the additional information of the plurality of records 114. In this way, if the user 103 indicates a transition from the filter mode 111 and/or a selection of one of the images VIF(1)-(x), the device 101 may have on its local memory 107, the associated one of the plurality of records 114 for that selected one of the images VIF(1)-(x) and can readily with minimal processing time, display the addition information in the results window 110.

FIG. 5 illustrates an example of data structures for the filtered records 114, including the image VIFs 115, the filtered option selection(s) 119 and the new data structure, the images and filter option selection(s) 120, which may be stored in databases in either or both of the computing architectures 105 for device 101 and/or 205 for the content server(s) 150. The filtered records 114 as shown in this example may be stored in either or both of databases 152 in FIGS. 1 and 252 in FIG. 2, or the filter mode modules 122 for device 101 and/or filter mode module 222 for content server(s) 150 may process the filtered records for display 102 on the device 101 without database storage. The filtered option selection(s) 119 shown in this example may be stored in either or both of databases 158 in FIGS. 1 and 258 in FIG. 2, or the filter mode module 122 for device 101 and/or filter mode module 222 for content server(s) 150 may process the filtered option selection(s) 119 without database storage. Similarly, the images and filter option selection(s) 120 shown in this example may be stored in either or both of databases 159 in FIGS. 1 and 259 in FIG. 2, or the filter mode module 122 for device 101 and/or filter mode module 222 for content server(s) 150 may process the images and filter option selection(s) 120 on the device 101 without database storage.

FIG. 5 also illustrates a process 500 by which data from separate databases may be combined to generate a new data structure of the images and filter option selection(s) 120. The filtered records 114 may include, in addition to the field of images VIF 115, additional fields such as a title description 116 field, a detailed description 117 field, etc. The filter option selections(s) 119 include one or more user 103 selections of the filter option(s) 118 presented to the user 103 on the device 101 display 102. Then, as described in FIG. 4, the image VIF 115 field of the filtered records 114 is retrieved and combined with the filter option selection(s) 120(1)-(x) associated with the image VIF 115 to create the new data structure image VIF and filtered option selection(s) 120.

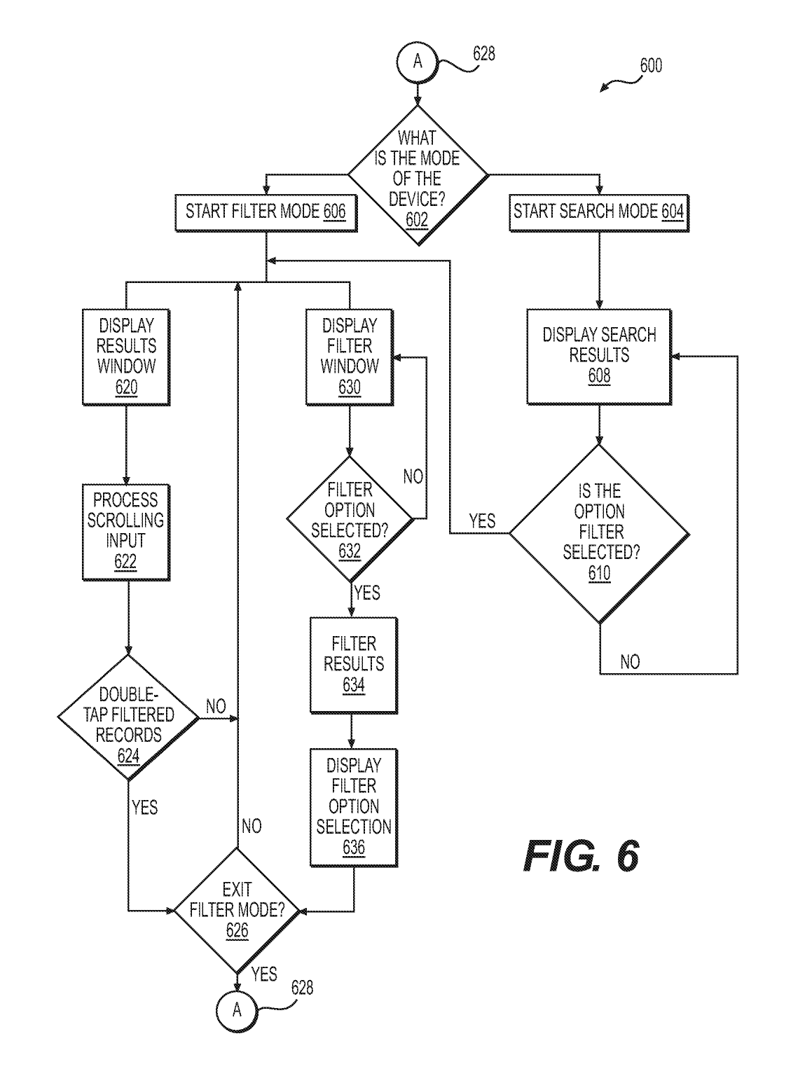

FIG. 6 is a flow diagram showing a process 600 for hosting the dynamic refinement of filtered results. The process 600 is illustrated as a collection of blocks in a logical-flow graph, which represent a sequence of operations that may be implemented in hardware, software, or a combination thereof. The blocks are referenced by numbers 602-636.

In the context of software, the blocks represent computer-executable instructions stored on one or more computer-readable media that, when executed by one or more processing units (such as hardware microprocessors), perform the recited operations. Generally, computer-executable instructions include routines, programs, objects, components, data structures, and the like, that perform particular functions or implement particular abstract data types. The order in which the operations are described is not intended to be construed as a limitation to embodiments of the invention. A client device, a remote content-item service, or both, may implement the described processes.

In one example of the process 600, at step 602, the device 101 processor(s) 106 determines the mode of the device 101 based on input by the user 103, which is detected by the user interface module 116. That is, the user interface module 116 determines whether the device 101 is in the filter mode 111 or the search mode 113. When the device 101 is in the filter mode 111, the filter mode module 122 is activated at step 606. When the device 101 is in the search mode 113, the search mode module 128 is activated at step 604.

The filter mode 111 operations are shown in steps 606 to 636. At steps 620 and 630, the filler mode module 122 activates both the results window module 124 and the filter window module 126 concurrently to support dynamic and mutual processing by each of the results window module 124 and filter window modules 126, respectively.

Continuing with the results window module 124 processing, at step 622, the module 124 enables the user 103 to execute a scrolling operation on the presentation of the filtered records 114, such as for example, interacting with the device 101 user interface 102 and touch screen 104 based on a number of options including touch and swipe, touch and hold, etc., to move a given image VIF 115(x) along the path of presentation of the images VIF 115(1)-(x). In the illustration shown in FIG. 1 and described above, the user 103 may touch a given image VIF 115(x) and then move her finger along a line along the length of the images VIF 115(1)-(x) presentation (as shown by line 127 in FIG. 1) to execute a scrolling operation.

The filter mode module 122 also processes the results window to detect other user interactions 103. For example, another option for the user 103 to interact with the images VIF 155(1)-(x) is to indicate, tap or double-tap on a given image VIF 115(x), with a double-tap being shown as one example in step 624. Continuing with this example, a double-tap may indicate that the image VIF 115 is selected in order to trigger a transition from the filter mode 111 to the search mode 113 of the device 101. There are alternative interactions which the user 103 may have with the image VIF 115(s), such as described above for the scrolling operation. If the user 103 interaction is not a double-tap, then the processor(s) 106 may then determine that a double-tap of the image VIF 115 (or record 114) has not occurred, in which case the processing 600 returns to the start of the filter mode step 606. In further alternative embodiments, other user 103 interactions may trigger other pre-determined actions with respect to image VIF 115(s), such as, for example, as is illustrated and described regarding FIG. 3B UI display 350. There are examples of a number of approaches and operations associated with interactions by the user 103 with image VIF 115s.

The filter mode 111 activation in step 606 also triggers the filter mode module 122 to process the filter window 112 at the same time as the results window, as described regarding FIGS. 1, 3A-3B above. An example of processing for the filter window 111 is shown in steps 630 to 636. They may include the filter window module 126 prompting the display of the filter window 112, including the filter options 118. The filter window module 126 may then determine whether one or more of the filter option selection(s) 119(1)-(x) have been selected by the user 103 based on a detection by the user interface module 116 of user 103 interaction with the filter window 112. As described in detail above, there are numerous approaches to selecting filter option selection(s) 119(1)-(x) on an individual basis, such as filter option selection 119(1), or on an aggregated basis, such as the selection of filter option selection(s) 119(1)-(x) followed by the user 103 selection of the “Refine” button 108. Within a given approach, in step 632, the filter window module 126 determines whether a filter option 119 has been selected. In the event that a filter option 119 has been selected, the processing 600 continues to step 634 in which either the individual or aggregated filter option selection(s) 120(1)-(x) are applied to the filtered records 114 to generate a new set of filtered records 114, which are then processed by the results window module 124 for display in the results window, in step 636. Where a filter option 119 has not been selected by the user 103, the filter window module 126 returns the processing to step 630. The processing then continues in step 626 for the processor(s) 106 to determine whether the filter mode 111 has been exited. In the event it has, the processing 600 in step 628 then returns to the determination by the processor(s) 10, in step 602, as to the mode, either the filter mode 111 or the search mode 113, of the device 101. In the event it has not, the processing 600 returns to the start of the filter mode step 606.

In one example, where a double-tap is pre-determined to initiate a transition from the filter mode 111 to the search mode 113, the processing 600 may continue as shown in step 624, where the user interface module 116 may detect the double-tap and the processor(s) 106 may then determine that a double-tap of the image VIF 115 (or record 114) has occurred. Based on a double-tap occurrence, in step 624, the processing 600, the processing 600 in step 628 then returns to the determination by the processor(s) 10, in step 602, as to the mode, either the filter mode 111 or the search mode 113, of the device 101.

From the step 602, and where the device 101 is in the search mode 113, the search mode module 128 is activated at step 604. The filter mode 113 operations are shown in steps 608 to 610. There are a number of approaches to initiating the search mode 113 for the device 101, such as when the device 101 is initialized, the search mode 111 may be the default mode, or there may be multiple user 103 interactions which may prompt the search mode 113, such as the double-tap of an image VIF 115, as described above in step 624, etc.

Upon activation of the search mode 113 in step 604, the search mode module 128 initiates the display of records 250 on the display 102 of the device 101. This is described in detail regarding FIG. 3A UI display 302. Also described regarding FIG. 3A are multiple approaches to initiating or transitioning to both the search mode 113 and the filter mode 113. In this example for the process 600, in step 610, the search mode module 128 determines whether the “Filter” button 108 (shown in FIG. 3A UI display 302) to initiate the filter mode 111. Where the user 103 interaction to initiate the filter mode 11 is detected by the processor(s) 106, the processing 600 then activates the filter mode module 122 shown in step 606. Where the user 103 interaction to initiate the filter mode 11 is not detected by the processor(s) 106, the processing 600 then returns to displaying the search results in step 608, as well as other search mode 113 activities (not shown).

Then, in step 412, the filter mode module 222 combines multiple data fields from separate databases to generate in step 414 a new data structure, such as the image VIF 115 field of the record 114 (from the images database 254) combined with the filter option selection(s) 120(1)-(x) (from the filter option selections database 260) associated with the image VIF 115.

### CONCLUSION

Although the subject matter has been described in language specific to structural features, it is to be understood that the subject matter defined in the appended claims is not necessarily limited to the specific features described. Rather, the specific features are disclosed as illustrative forms of implementing the claims.

What is claimed is:

1. A device comprising:
one or more processors;
a user interface;
a network interface for communication with a server; and
a memory including computer-executable instructions that, when executed, cause the one or more processors to:
render a results window and a filter window concurrently on the interface, the results window including a plurality of visual identification fields and displaying at least some of the plurality of visual identification fields and the filter window displaying a plurality of filter options;
detect a first user of one of the plurality of filter options;
upon detection of the first user selection, transmit to the server the selected one of the plurality of filter options and a request for a filter operation in order to generate a first filtered plurality of visual identification fields, receive from the server the first filtered plurality of visual identification fields and update the results window by displaying on the results window at least some of the first filtered plurality of visual identification fields, wherein a first processing time is associated with the time period from detection of the first user selection to displaying on the results window the first filtered plurality of visual identification fields;
transmit to the server a predetermined second one of the plurality of filter options and a request for a pre-fetch operation for a second filtered plurality of visual identification fields, receive the second filtered plurality of visual identification fields and store the second plurality of visual identification fields in the memory, wherein the second filtered plurality of visual identification fields is associated with the predetermined second one of the plurality of filter options;
detect a second user selection of the predetermined second one of the plurality of filter options based on the filter window being operable to receive the second user selection concurrently with the results window being operable to display at least some of the first filtered plurality of visual identification fields;
upon detection of the second user selection, update the results window by displaying on the results window at least some of the second filtered plurality of visual identification fields, wherein a second processing time is associated with the time period from detection of the second user selection to displaying on the results window the second filtered plurality of visual identification fields and the second processing time is shorter than the first processing time based at least in part on the pre-fetch operation.

2. The device of claim 1, wherein computer-executable instructions further cause the one or more processors to:
detect a user input on the results window based on the results window being operable to receive the user input concurrently with the filter window being operable to receive another user selection of another one of the plurality of filter options; and
upon detection of the user input, reposition at least one of the second filtered plurality of visual identification fields in the results window.

3. The device of claim 2, wherein computer-executable instructions further cause the one or more processors to detect a third user selection of one of the plurality of filter options based on the filter window being operable to receive the third user selection concurrently with the results window being operable to display at least some of the second filtered plurality of visual identification fields.

4. The device of claim 2, wherein the detect the user input on the results window comprises detecting a gesture by the user to reposition at least one of the second filtered plurality of visual identification fields outside the display of the results window, and wherein computer-executable instructions further cause the one or more processors to change the display of the results window such that at least one of the second filtered plurality of visual identification fields is newly visible on the results window.

5. The device of claim 1, wherein computer-executable instructions further cause the one or more processors to transmit to the server a request for a pre-fetch operation for a plurality of records associated with the first plurality of visual identification fields, receive the plurality of records and store the plurality of records in the memory for availability upon detection of a user input on the results window of one of the first plurality of visual identification fields for selection of the one of the first plurality of visual identification fields to access additional information in the associated one of the plurality of records.

6. A device comprising:
one or more processors;
a user interface;
a network interface for communication with a server; and
a memory including computer-executable instructions that, when executed, cause the one or more processors to:
render a results window and a filter window concurrently on the interface, the results window including a plurality of visual identification fields and displaying at least some of the plurality of visual identification fields and the filter window displaying a plurality of filter options;
detect a first user selection of one of the plurality of filter options; while continuing to maintain the results window to concurrently display at least some of the plurality of visual identification fields; and
upon detection of the first user selection, transmit to the server the selected one of the plurality of filter options and a request for a filter operation in order to generate a first filtered plurality of visual identification fields, receive from the server the first filtered plurality of visual identification fields and update the results window by displaying on the results window at least some of the first filtered plurality of visual identification fields.

7. The device of claim 6, wherein computer-executable instructions further cause the one or more processors to:
detect a second user selection of one of the plurality of filter options based on the filter window being operable to receive the second user selection concurrently with the display of at least some of the filtered plurality of visual identification fields and to detect a user input in order to reposition at least one of the first filtered plurality of visual identification fields;
detect the user input on the results window based on the results window being operable to receive the user input concurrently with the filter window being operable to receive another user selection of another one of the plurality of filter options; and
upon detection of the user input, reposition on the results window at least some of the first filtered plurality of visual identification fields at approximately the same time.

8. The device of claim 7, wherein computer-executable instructions further cause the one or more processors to maintain the filter window as operable concurrently during the processing of the results window to detect the user input and to reposition at least one of the first filtered plurality of visual identification fields.

9. The device of claim 7, wherein computer-executable instructions further cause the one or more processors to detect a third user selection of one of the plurality of filter options based on the filter window being operable to receive the third user selection concurrently with the results window being operable to display at least some of the first filtered plurality of visual identification fields.

10. The device of claim 7, wherein the detect the user input on the results window comprises detecting a gesture by the user to reposition at least one of the first filtered plurality of visual identification fields outside the display of the results window, and wherein computer-executable instructions further cause the one or more processors to change the display of the results window such that at least one of the first filtered plurality of visual identification fields is newly visible on the results window.

11. The device of claim 10, wherein the gesture by the user comprises one of a scrolling gesture, a swiping gesture, a dynamic sliding gesture, a selection of one of the filtered plurality of visual identification fields, or a physical or audio gesture without the user contacting the display screen.

12. The device of claim 6, wherein a first size of the plurality of visual identification fields compared to a second size of the filtered plurality of visual identification fields is one of the same or greater.

13. The device of claim 6, wherein the first user selection or the second user selection further comprises at least two of the plurality of filter options and further comprising instructions that, when executed by the one or more processors, cause the device to transmit to the server for the one of the first user selection or the second user selection, the at least two of the plurality of filter options.

14. The device of claim 6, wherein computer-executable instructions further cause the one or more processors to, prior to the detection of the second user selection, transmit to the server a predetermined one of the plurality of filter options and a request for a pre-fetch operation for a second filtered plurality of visual identification fields, receive the second filtered plurality of visual identification fields and store the second plurality of visual identification fields in the memory, wherein the second filtered plurality of visual identification fields is associated with the predetermined one of the plurality of filter options, and wherein the second user selection of the one of the plurality of filter options is the predetermined one of the plurality of filter options.

15. The device of claim 14, wherein computer-executable instructions further cause the one or more processors to, upon detection of the second user selection, update the results window by displaying on the results window at least some of the second filtered plurality of visual identification fields, wherein the processing time from detection of the second user selection to displaying on the results window the second filtered plurality of visual identification fields is shorter than the processing time from detection of the first user selection to displaying on the results window the first filtered plurality of visual identification fields.

16. The device of claim 6, wherein computer-executable instructions further cause the one or more processors to:
detect the user input on the results window based on the results window being operable to receive the user input concurrently with the filter window being operable to receive another user selection of another one of the plurality of filter options; and
upon detection of the user input, transmit to the server the selected one of the plurality of visual identification fields and a request for an operation to identify a set of the plurality of filter options associated with the selected one of the plurality of visual identification fields, receive from the server the set of the plurality of filter options and update the filter window by displaying on the filter window at least some of the set of the plurality of filter options.

17. The device of claim 16, where the at least some of the set of the plurality of filter options is one of the set of the plurality of filter options or selected ones of the set of the plurality of filter options which previously have been received as user input on the filter window.

18. A system comprising:
a network interface for communication with a device;
one or more processors; and
a memory including computer-executable instructions that, when executed, cause the one or more processors to:
store a plurality of records including a plurality of visual identification fields, each one of the plurality of records associated with one of the plurality of visual identification fields;
store a plurality of filter options;
receive from the device one of the plurality of filter options and a request for a filter operation;
execute the filter operation based on applying the one of the plurality of filter options to the plurality of records and generating a filtered plurality of records associated with the one of the plurality of filter options;
identify a filtered plurality of visual identification fields associated with the filtered plurality of records;
transmit to the device the filtered plurality of visual identification fields;
process the one of the plurality of filter options received from the device in order to identify a predetermined one of the plurality of filter options which has been received by the system as the next one of the plurality of filter options after the one of the plurality of filter options in past processing of the request from the device;
execute the filter operation based on applying the predetermined one of the plurality of filter options to the plurality of records and generating a new filtered plurality of records associated with the predetermined one of the plurality of filter options;
identify a filtered plurality of visual identification fields associated with the new filtered plurality of records; and
store the predetermined one of the plurality of filter options and the new filtered plurality of visual identification fields for availability upon a request from the device for a filter operation based on the predetermined one of the plurality of filter options.

19. The system of claim 18, further comprising instructions that, when executed by the one or more processors, cause the system to transmit to the device the predetermined one of the plurality of filter options and the new filtered plurality of visual identification fields.

20. The system of claim 18, further comprising instructions that, when executed by the one or more processors, cause the system to:
receive an additional one of the filter options from the device;
execute the filter operation based on applying the one of the plurality of filter options and the additional one of the plurality of filter options to the plurality of records and generating a filtered plurality of records associated with both of the one of the plurality of filter options and the additional one of the plurality of filter options;
identify a filtered plurality of visual identification fields associated with the filtered plurality of records; and
transmit to the device the filtered plurality of visual identification fields.
